(19) United States
(12) Patent Application Publication
(10) Pub. No.: US 2021/0132459 A1
(43) Pub. Date: May 6, 2021

(54) THREE-DIMENSIONAL, COLOR-CHANGING OBJECTS INCLUDING A LIGHT-TRANSMISSIVE SUBSTRATE AND AN ELECTROPHORETIC MEDIUM

(71) Applicant: E Ink Corporation, Billerica, MA (US)

(72) Inventor: Stephen BULL, Windham, NH (US)

(21) Appl. No.: 17/088,762

(22) Filed: Nov. 4, 2020

Related U.S. Application Data
(60) Provisional application No. 62/930,545, filed on Nov. 4, 2019.

(51) Int. Cl. G02F 1/167; G02F 1/1676; G02F 1/16755; G02F 1/1343; G02F 1/1333; G02F 1/1341; G02F 1/16757

(52) U.S. Cl. CPC G02F 1/167; G02F 1/1676; G02F 1/16755; G02F 1/13439; G02F 2001/1678; G02F 1/1341; G02F 1/16757; G02F 2202/28; G02F 1/133305

(57) ABSTRACT

A method for making a non-planar (three-dimensional) electrophoretic display including a light-transmissive front substrate that functions as a viewing surface. A light-transmissive conductive layer is incorporated into, or adhered to, the light-transmissive front substrate, whereupon a layer of electrophoretic encapsulated media is attached thereto. After the electrophoretic medium is deposited, a back electrode is attached or deposited. When a voltage is provided between the light-transmissive conductive layer and the back electrode, the image state of the electrophoretic medium is switched, thereby creating a color-changing surface. Such a color-changing surface can be incorporated into a toy, an appliance, an electronic device, or other suitable structure.

### RELATED APPLICATIONS

This application claims priority to U.S. Provisional Patent Application No. 62/930,545, filed Nov. 4, 2020. All patents and publications referenced herein are incorporated by reference in their entireties.

### BACKGROUND OF INVENTION

This invention relates to electro-optic displays and processes for the production thereof. More specifically, this invention relates to processes for the production of electro-optic displays without the use of front plane laminates, inverted front plane laminates and double release films as described in U.S. Pat. Nos. 6,982,178; 7,561,324; and 7,839,564, and to processes for depositing encapsulated electrophoretic media by spraying.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods); the display itself can be made inexpensively.

The electrophoretic media typically comprise electrophoretic particles, charge control agents, image stability agents and flocculants in a non-polar liquid, typically encapsulated in a flexible organic matrix such as a gelatin/acacia coacervate. To produce commercial displays, it is necessary to coat a thin layer (preferably a monolayer—see U.S. Pat. No. 6,839,158) of capsules on a substrate, which may be a front substrate bearing an electrode (see the aforementioned U.S. Pat. No. 6,982,178), a backplane or a release sheet. Hitherto, coating of encapsulated electrophoretic media on substrates has typically been effected by slot coating, in which a slurry of capsules in a carrier medium is forced through a slot on to a substrate that is moving relative to the slot. Slot coating imposes limitations upon the viscosity and other physical properties of the material being coated and typically requires the addition of slot coating additives to control the rheology of the coated material to ensure that the coating does not flow and develop non-uniformities in thickness prior to drying. Thus, in slot coating electrophoretic capsules are typically supplied in the form of aqueous slurries containing optional latex binder, rheology modification agents, ionic dopants, and surfactants. These additives remain in the final dried electrophoretic medium and may affect its properties, including its electro-optic properties.

Furthermore, although slot coating is well adapted for applying electrophoretic media to continuous webs, it is not well adapted for coating irregularly-shaped objects. That is, slot coating is generally not useful for non-planar substrates, which is unfortunate because encapsulated electrophoretic media are well adapted for providing color-changing capacity to three-dimensional objects.

### SUMMARY OF INVENTION

As described herein, the invention provides a method for making color-changing objects of many different shapes, for example, sub-assemblies of larger objects that are put together to create commonly encountered objects, such as toys, appliances, and electronics. Such shapes are generally termed “three-dimensional” for the purposes of understanding the invention. “Three-dimensional,” as used herein, is intended to exclude substantially-planar objects similar to front plane laminates, display modules, and slightly bent objects, such as a foldable displays. Although not intended to be limiting, one definition of “three-dimensional” may be having curvature in more than two perpendicular directions, for example a bowl, a cylinder, a pyramid, a sphere, a cone, a helix, an ellipsoid, a hemi-ellipsoid, etc. In this document, “non-planar” may be used interchangeably with “three-dimensional.”

In a first aspect, the invention provides a color-changing object including a light-transmissive (three-dimensional) non-planar substrate, a light-transmissive front conductor, a layer of encapsulated electrophoretic media, and a back conductor. In some embodiments, the color changing object additionally includes one or more adhesive layers to facilitate construction of the object. The light-transmissive non-planar substrate can be constructed from a clear material, generally, however, the more likely choices are light-transmissive polymers such as polyethylene terephthalate (PET), polycarbonate, polypropylene, acrylic, or cyclic olefin copolymer (COC). The light-transmissive conductor may be a separate layer or it may be integrated into the light-transmissive non-planar substrate. The light-transmissive front conductor may be constructed with metal flakes, metal screen, conductive polymers, carbon nanotubes or a combination thereof.

In a second aspect, the invention provides a method of making a color-changing object, including providing a light-transmissive non-planar substrate, disposing a light-transmissive conductive material adjacent the inside surface of the light-transmissive non-planar substrate, thereby making the outside surface of the light-transmissive non-planar substrate the viewing surface, disposing a layer of encapsulated electrophoretic media adjacent the light-transmissive conductive material, and disposing a back conductor adjacent the layer of encapsulated electrophoretic media. Further embodiments may include providing a voltage source and coupling the light-transmissive conductive material and the back conductor to the voltage source. The light-transmissive non-planar substrate is thermoformed, cast, injection molded, or blow-molded. The process of disposing light-transmissive conductive material comprises spray coating, sputtering, atomic layer deposition, vapor deposition, or dip coating. The process of disposing a layer of encapsulated electrophoretic media adjacent the light-transmissive conductive material may include spray-coating, dip coating, electrodeposition, powder coating, silk screening, or brush-painting.

Spray-coating the encapsulated electrophoretic medium may include forming a dispersion of capsules in a liquid, feeding the dispersion through a first orifice, and feeding a continuous stream of gas through a second, annular orifice surrounding the first orifice, thereby forming a spray of the capsules. The spray-coating process may include shaping the spray by feeding a continuous stream of gas through a plurality of shaping orifices disposed adjacent the spray. If, as is typically the case, the capsule walls are formed from a hydrophilic material (such as the aforementioned gelatin/acacia coacervate), the liquid used to disperse the capsules is desirably aqueous; depending upon the specific capsules and liquid used, the liquid may optionally comprise any one or more of pH modifiers, surfactants and ionic dopants. The gas passed through both the second orifice and the shaping orifices is typically air, but it some cases it may be useful to use an inert gas, for example nitrogen.

In spray-coating embodiments, the process may include the use of a masking material covering part of the substrate so that, after removal of the masking material, capsules remain only on those portions of the substrate where the masking material was not present. Such a technique may facilitate making an electrical connection between the light-transmissive conductive material and the back conductor.

### BRIEF DESCRIPTION OF DRAWINGS

FIG. 1 shows a cross-sectional view of an embodiment of an electrophoretic display of the invention including a light-transmissive non-planar substrate including a light-transmissive conductor that is coupled to a voltage source. The voltage source is also coupled to a back conductor. A layer of encapsulated electrophoretic media is disposed between the light-transmissive conductor and the back conductor. One or more adhesive layers may also be present.

FIG. 2 illustrates that a variety of common objects can be made to be color-changing by molding a light-transmissive substrate and adding a front conductor, a layer of electrophoretic media, and a back conductor.

FIG. 3A illustrates a process for making a color-changing non-planar display of the invention.

FIG. 3B illustrates a process for making a color-changing non-planar display of the invention.

FIG. 4 illustrates an embodiment of a nozzle suitable for spray-coating encapsulated electrophoretic media.

FIG. 5 shows the preferred range of operation of a spray-coating embodiment of the invention.

### DETAILED DESCRIPTION

The invention includes, inter alfa, a method for making a non-planar electrophoretic display including a light-transmissive front substrate that functions as a viewing surface. A light-transmissive conductive layer is incorporated into, or adhered to, the light-transmissive front substrate, whereupon a layer of electrophoretic encapsulated media is attached thereto. After the electrophoretic medium is deposited, a back electrode is attached or deposited. When a voltage is provided between the light-transmissive conductive layer and the back electrode, the image state of the electrophoretic medium is switched, thereby creating a color-changing surface. Such a color-changing surface can be incorporated into, e.g., a toy, an appliance, an electronic device, or other suitable structure.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728; and 7,679,814;
(b) Capsules, binders and encapsulation processes; see for example U.S. Pat. Nos. 6,922,276; and 7,411,719;
(c) Films and sub-assemblies containing electro-optic materials; see for example U.S. Pat. Nos. 6,825,829; 6,982,178; 7,236,292; 7,443,571; 7,513,813; 7,561,324; 7,636,191; 7,649,666; 7,728,811; 7,729,039; 7,791,782; 7,839,564; 7,843,621; 7,843,624; 8,034,209; 8,068,272; 8,077,381; 8,177,942; 8,390,301; 8,482,852; 8,786,929; 8,830,553; 8,854,721; and 9,075,280; and U.S. Patent Applications Publication Nos. 2009/0109519; 2009/0168067; 2011/0164301; 2014/0027044; 2014/0115884; and 2014/0340738;
(d) Backplanes, adhesive layers and other auxiliary layers and methods used in displays; see for example U.S. Pat. Nos. D485,294; 6,124,851; 6,130,773; 6,177,921; 6,232,950; 6,252,564; 6,312,304; 6,312,971; 6,376,828; 6,392,786; 6,413,790; 6,422,687; 6,445,374; 6,480,182; 6,498,114; 6,506,438; 6,518,949; 6,521,489; 6,535,197; 6,545,291; 6,639,578; 6,657,772; 6,664,944; 6,680,725; 6,683,333; 6,724,519; 6,750,473; 6,816,147; 6,819,471; 6,825,068; 6,831,769; 6,842,167; 6,842,279; 6,842,657; 6,865,010; 6,967,640; 6,980,196; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,280,094; 7,327,511; 7,349,148; 7,352,353; 7,365,394; 7,365,733; 7,382,363; 7,388,572; 7,442,587; 7,492,497; 7,535,624; 7,551,346; 7,554,712; 7,583,427; 7,598,173; 7,605,799; 7,636,191; 7,649,674; 7,667,886; 7,672,040; 7,688,497; 7,733,335; 7,785,988; 7,843,626; 7,859,637; 7,893,435; 7,898,717; 7,957,053; 7,986,450; 8,009,344; 8,027,081; 8,049,947; 8,077,141; 8,089,453; 8,208,193; 8,373,211; 8,389,381; 8,498,042; 8,610,988; 8,728,266; 8,754,859; 8,830,560; 8,891,155; 8,989,886; 9,152,003; and 9,152,004; and U.S. Patent Applications Publication Nos. 2002/0060321; 2004/0105036; 2005/0122306; 2005/0122563; 2007/0052757; 2007/0097489; 2007/0109219; 2009/0122389; 2009/0315044; 2011/0026101; 2011/0140744; 2011/0187683; 2011/0187689; 2011/0292319; 2013/0278900; 2014/0078024; 2014/0139501; 2014/0300837; 2015/0171112; 2015/0205178; 2015/0226986; 2015/0227018; 2015/0228666; and 2015/0261057; and International Application Publication No. WO 00/38000; European Patents Nos. 1,099,207 B1 and 1,145,072 B1;
(e) Color formation and color adjustment; see for example U.S. Pat. Nos. 7,075,502; and 7,839,564;
(f) Methods for driving displays; see for example U.S. Pat. Nos. 7,012,600; and 7,453,445;
(g) Applications of displays; see for example U.S. Pat. Nos. 7,312,784; and 8,009,348; and
(h) Non-electrophoretic displays, as described in U.S. Pat. Nos. 6,241,921; 6,950,220; 7,420,549; 8,319,759; and 8,994,705; and U.S. Patent Application Publication No. 2012/0293858.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface. [Para 24] The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The light-transmissive conductive material may be, for example, a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trade Mark) from E.I. du Pont de Nemours & Company, Wilmington DE, and such commercial materials may be used with good results in the front plane laminate. The light-transmissive conductive material may also include metal flakes, metal screen, conductive polymers, carbon nanotubes, graphene, or a combination thereof.

In an electrophoretic display, there are often one or more adhesive layers in the stack of layers. For example, there may be an adhesive layer between the electrophoretic layer and an electrode, and this layer of adhesive remains in the final display. Of course, this adhesive layer has significant effects on the electro-optic properties of the display. Inevitably, some of the voltage drop between the electrodes occurs within the adhesive layer, thus reducing the voltage available for driving the electrophoretic layer. The effect of the adhesive tends to become greater at lower temperatures, and this variation in the effect of adhesive with temperature complicates the driving of the display. The voltage drop within the adhesive can be reduced, and the low temperature operation of the display improved, by increasing the conductivity of the adhesive layer, for example by doping the layer with tetrabutylammonium hexafluorophosphate or other materials as described in U.S. Pat. Nos. 7,012,735 and 7,173,752.

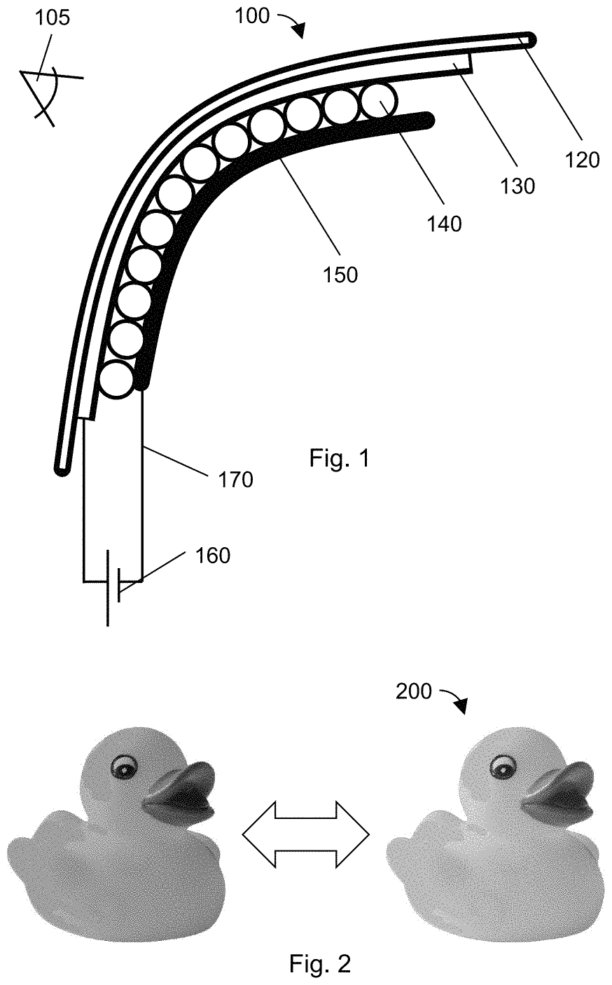

A cross section of an exemplary color-changing object 100 can be seen in FIG. 1, wherein the viewing surface is opposed to the viewer 105. The color-changing object 100 is built up from a light-transmissive non-planar substrate 120, and then a light-transmissive front conductor 130 is added as a separate layer or integrated into the light-transmissive non-planar substrate 120. After the light-transmissive non-planar substrate 120 and light-transmissive front conductor 130 are integrated, a layer of encapsulated electrophoretic media 140 is disposed upon the integrated layers 120 and 130. Finally, a back conductor 150 is disposed on the layer of encapsulated electrophoretic media 140, thereby completing the color-changing object 100. After completion, the light-transmissive front conductor 130 and the back conductor 150 are connected to a voltage source 160 with an electrical connector 170 (e.g., a wire or a trace). When a voltage is applied between the light-transmissive front conductor 130 and the back conductor 150 electrophoretic particles in the encapsulated electrophoretic medium will move toward (or away from) the viewer 105, thereby producing the effect of a color change in the color-changing object 100. The voltage source 160 may be, for example, a D.C. voltage source, and it may be configured to provide one, two, three, four, five, six, seven, eight, or nine voltage levels. In some embodiments, the voltage source 160 will provide a time varying voltage signal that may look like square waves in a voltage vs. time profile. The time varying voltage may be ramped, saw-toothed, or sinusoidal The voltage source 160 may supply a continuum of voltage levels and time dependencies, allowing unique application of voltage signals. In some embodiment, multiple voltage sources 160 may be coupled between the front conductor 130 and the back conductor 150.

The layer of encapsulated electrophoretic medium may comprise more than one type of charged pigment particles, e.g., as described in the patent above. Accordingly, the color-changing object 100 may alternate between, for example, white and black. Alternatively, the layer of encapsulated electrophoretic media 140 may comprise three particles wherein the first set of charged pigment particles is red, the second set of charged pigment particles is green, and the third set of charged pigment particles is blue. Alternatively, the layer of encapsulated electrophoretic media 140 may comprise three particles wherein the first set of charged pigment particles is red, the second set of charged pigment particles is black, and the third set of charged pigment particles is white. Alternatively, the layer of encapsulated electrophoretic media 140 may comprise four particles wherein the first set of charged pigment particles is white, the second set of charged pigment particles is cyan, the third set of charged pigment particles is yellow, and the fourth set of charged pigment particles is magenta. Some sets of the charged pigment particles may be primarily light-scattering (e.g., reflective), while other sets may be subtractive (e.g., absorptive), while other sets may be light-transmissive. Alternatively, the layer of encapsulated electrophoretic media 140 may comprise four particles wherein the first set of charged pigment particles is red, the second set of charged pigment particles is green, the third set of charged pigment particles is blue, and the fourth set of charged pigment particles is black. Alternatively, the layer of encapsulated electrophoretic media 140 may comprise four particles wherein the first set of charged pigment particles is red, the second set of charged pigment particles is yellow, the third set of charged pigment particles is blue, and the fourth set of charged pigment particles is black. Alternatively, the layer of encapsulated electrophoretic media 140 may comprise five sets of charged particles wherein the first set of charged pigment particles is red, the second set of charged pigment particles is yellow, the third set of charged pigment particles is blue, the fourth set of charged pigment particles is black, and the fifth set of charged pigment particles is white.

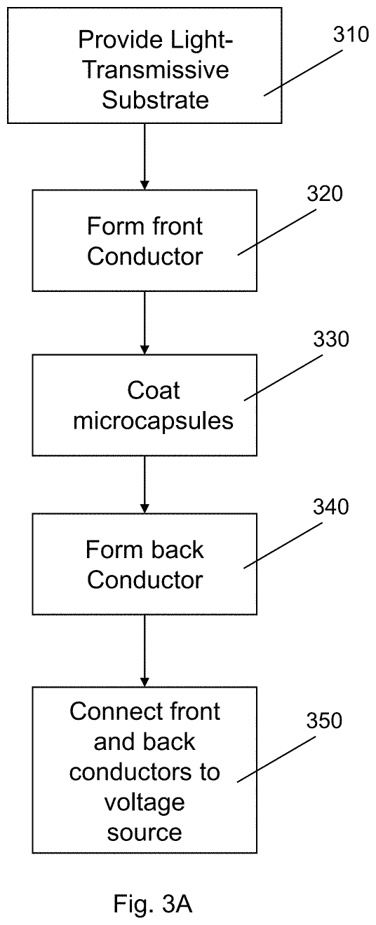

It is to be understood that the color-changing object 100 need not be rigid, and can be flexible to the degree that bending does not cause rupture of the capsules within the layer of encapsulate electrophoretic media or cause the connections in the light-transmissive front conductor 130 or the back conductor 150 to fail. For example, the light-transmissive non-planar substrate 120 may comprise a clear polymer, such as polyethylene terephthalate (PET), polycarbonate, polypropylene, acrylic, or cyclic olefin copolymer (COC). It is appropriate for the light-transmissive non-planar substrate 120 to be only partially light-transmissive, e.g., translucent and/or tinted. Such a light-transmissive non-planar substrate 120 may give rise to a color-changing toy 200, such as shown in FIG. 2. Because the electrophoretic medium only requires a small amount of power, and because the electrophoretic states are bistable, it is possible to achieve such color-change features with a small energy source (e.g., a disposable battery) that is hidden within the color-changing object 100.

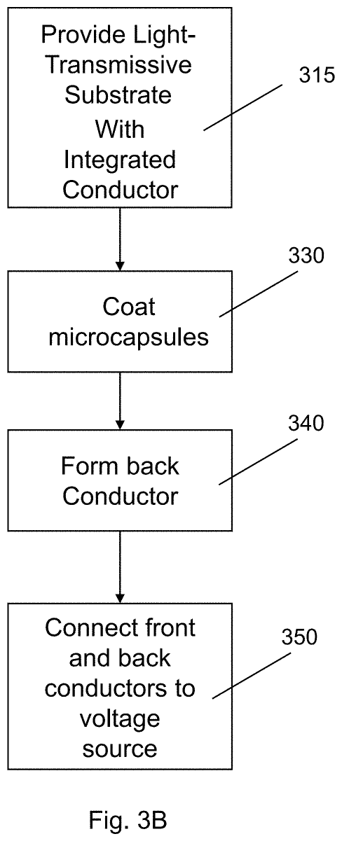

A method of making a color-changing object 100 is described with respect to the flow chart in FIG. 3A. Beginning with step 310 a light-transmissive non-planar substrate is provided. As discussed above, the light-transmissive non-planar substrate may comprise a clear polymer; however, other light-transmissive materials, such as glass, are also suitable. The light-transmissive non-planar substrate may be shaped before the process begins with a process such as thermoforming, casting, injection molding, blow-molding, grinding, etching, or cutting. After the light-transmissive substrate is provided in step 310, a front (light-transmissive) conductor is coupled to or integrated into the light-transmissive substrate at step 320. In some embodiments, the front (light-transmissive) conductor may include an additional light-transmissive substrate, such as a PET film. As shown in FIG. 3B, in the instance that the front conductor material is integrated into the light-transmissive non-planar substrate 315, it is possible for the combination of the light-transmissive non-planar substrate and the front conductor to be shaped together, e.g., with thermoforming, blow molding, etc. Typically, the front (light-transmissive) conductor material comprises metal flakes, metal screen, conductive polymers, carbon nanotubes, graphene or a combination thereof. The front (light-transmissive) conductor material may be formed from a conductive polymer, for example poly(3,4-ethylenedioxythiophene) (“PEDOT”), normally used in the form of its poly(styrenesulfonate) salt (“PEDOT:PSS”) or a polyaniline, or may be formed from network of conductors, for example carbon nanotubes or nanowires. If the front (light-transmissive) conductor material is not integrated into the light-transmissive non-planar substrate, it may be separately added to the light-transmissive non-planar substrate using a process such as spray coating, sputtering, atomic layer deposition, vapor deposition, painting, or dip coating.

Once the light-transmissive non-planar substrate and the front conductor have been integrated, the resulting structure is coated with a layer of an encapsulated electrophoretic medium in step 330. This step may be accomplished using a process such as spray coating, dip coating, electrodeposition, powder coating, silk screening, or brush-painting. The encapsulated electrophoretic medium may be delivered as a slurry of capsules and a polyurethane binder, or the encapsulated electrophoretic medium may be delivered “freeze dried”, i.e., after lyophilization. In order to provide a voltage across the electrophoretic medium to actuate the optical states, a back conductor is next formed on the layer of encapsulated electrophoretic media in step 340. The back conductor need not be light-transmissive; however, it may be light-transmissive. The back conductor may comprise, for example, metal flakes, metal screen, metal foil, metal paint, conductive polymers, carbon nanotubes, graphene, graphite or a combination thereof. Finally, once the front and back conductors are present, they may be connected to a voltage source in step 350. In some instances, it is useful to mask off a portion of the front conductor with, e.g., masking tape, prior to coating the non-planar object with the encapsulated medium and the back conductor. Accordingly, once the mask is removed, clear access to the front conductor is provided to allow easy coupling of the front and back conductors to the voltage source. Alternatively, a masking layer may be formed from a simple polymeric film that adheres to the backplane either because of its own physical properties or with the aid of an adhesive coating, but should desirably not be more than about 75 μm in thickness. Polymeric films that have been found useful as masking layers include Kapton tape (a polyimide tape available from du Pont de Nemours & Company, Wilmington, DE) and RP301 film (an acrylic film available form Nitto America, Inc., Fremont Calif.). The solid electro-optic layer is typically an encapsulated electrophoretic layer but may also be a polymer-dispersed electrophoretic layer or a rotating bichromal member or electrochromic layer. The material used to form the front electrode and the adhesive can be any of the materials used in the prior art for this purpose.

For both the front (light-transmissive) conductor and the back conductor, an electrically conductive layer is disposed above and below, respectively, of the layer of encapsulated electrophoretic media. As discussed for example in the aforementioned U.S. Pat. No. 6,982,178, polymeric films coated with indium tin oxide (ITO) are available commercially and are suitable for providing the front and the rear conductors. In some embodiments, an adhesive layer (not shown in figures) can be applied, e.g., between the light-transmissive non-planar substrate and the front (light-transmissive) conductor, or between the front (light-transmissive) conductor and the layer of encapsulated electrophoretic media, or between the layer of encapsulate electrophoretic media and the back conductor. Such an adhesive may be cured, e.g., with heat and/or pressure, or the adhesive may be radiation-cured with ultraviolet radiation.

The front electrode layer 312 may be formed from a conductive polymer, for example poly(3,4-ethylenedioxythiophene) (“PEDOT”), normally used in the form of its poly(styrenesulfonate) salt (“PEDOT:PSS”) or a polyaniline, or may be formed from network of conductors, for example carbon nanotubes or nanowires. The present inventors have successfully coated both PEDOT and carbon nanotube front electrodes directly on an encapsulated electrophoretic layer.

Spray Coating Process

As already mentioned, this invention may be constructed by spraying capsules of an electrophoretic medium on to a substrate. This process comprises forming a dispersion of the capsules in a liquid; feeding the dispersion through a first orifice; and feeding a continuous stream of gas through a second, annular orifice surrounding the first orifice, thereby forming a spray of the capsules. This spray coating process has the advantage over slot coating that spray coating normally does not require the use of rheology modifiers in the liquid being sprayed, so that the final coating is free from such rheology modifiers and hence free from the effects such rheology modifiers may have upon the properties of slot coated electrophoretic media. Typically, in spray coating, only the additives actually needed in the final product need be added to the liquid being sprayed.

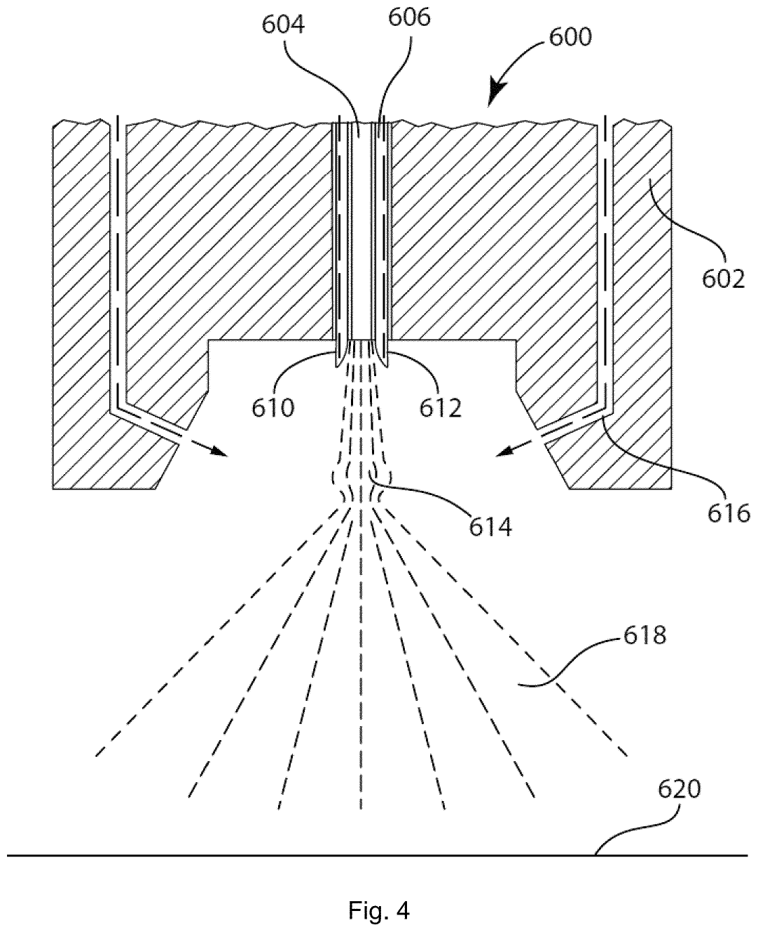

FIG. 4 is a schematic cross-section through a simple spray coating nozzle (generally designated 600) that may be used in the spray coating process of the present invention. The nozzle 600 comprises a substantially cylindrical body 602 having a central, axial bore 604 through which is pumped electrophoretic capsules (not shown) dispersed in a liquid (also not shown). The central bore 604 is surrounded by an annular bore 606, through which is forced a continuous stream of air. The lower end of the central bore 604 terminates in an orifice 608, which the lower end of the annular bore 606 terminates in an annular orifice 610, which surrounds orifice 608. A cylindrical baffle 612 surrounds the annular orifice 610. The air flow through the annular orifice 610 constrained by the baffle 612 causes the dispersion of capsules passing through orifice 608 to form a spray or jet 614.

The nozzle 600 is also provided with shaping air bores 616, which may be six or eight in number. As shown in FIG. 4, the peripheral portions of the nozzle 600, through which the bores 616 pass, extend downwardly below the orifices 608 and 610 and the baffle 612, and the lower portions of the bores 616 are directly downwardly and inwardly. Shaping air is forced continuously through the bores 616 so that it impinges on the jet 614, thereby causing the jet to open out into a wide spray 618, which impinges on a substrate 620 disposed below the nozzle 600.

The quality of capsules coatings is assessed in terms of their reproducibility granularity, mean coating weight, uniformity and defect density; defect density is quantified by the number of non-switching capsules per unit display area in a standard display structure, which for present purposes is defined as a backplane bearing, in order, a 25 μm layer of lamination adhesive, a 20 μm capsule layer and a front substrate comprising an ITO layer on 25 μm polyethylene terephthalate film. Preferably, the ratio of atomization air outlet cross-section to capsule dispersion outlet cross section is not greater than about 8.5, and preferably between about 5.0 and about 7.0. The capsule dispersion orifice diameter is preferably in the range of about 1.0-1.40 mm. The capsule dispersion may contain capsules in a weight fraction preferably between about 38.0 and about 40.5 weight percent; this dispersion may optionally contain 1-butanol at a concentration of up to about 4.0 weight percent and a surfactant, such as Triton X-100 at a concentration of up to about 0.04 weight percent.

A wide range of capsule dispersion feed rates and atomization air feed rates can be used in the spray coating process of the present invention. Typically, the capsule dispersion feed rate, MF, is not less than about 30 g/min and not greater than about 70 g/min, the optimum being determined mainly on the basis of an appropriate residence time in the atomization zone, that is to say the region in which the capsule dispersion column emerging from the first orifice breaks into sheets of fluid, which subsequently break into ligaments and finally droplets. Desirably, the droplet size distribution is such that the mean capsule count per droplet is less than about 5.0, and the standard deviation is less than about 3.0, capsules per droplet. The atomization air feed rate is set on the basis of a critical air velocity, v*, measured at the second orifice, and is typically of the order of about 100 m/sec. In the preferred process, a total air feed rate, MA, (including atomization air and shaping air) of approximately 150 to 200 g/min is employed in the absence of shaping air, and up to 300 g/min with shaping air.

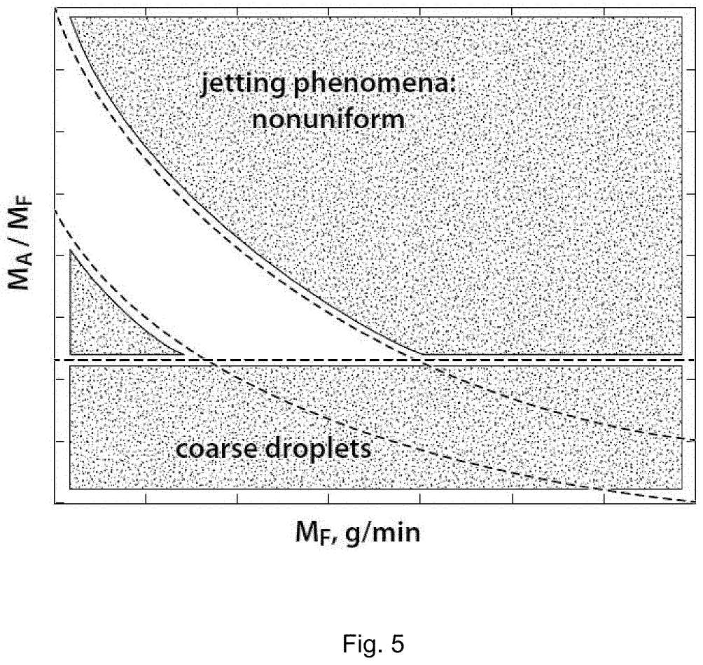

Empirically, it has been found that the operating window for HVLP atomization in terms of MA/MF versus MF, has the form shown in FIG. 5, although the numerical values involved will vary with the particular nozzle design used. The unshaded region of the graph of FIG. 5 represents the desirable operating window. The shaded regions represent defect regions which result in undesirable spray patterns such as excessive fluid velocity (“jetting”), highly irregular and transient spray structure, and coarse droplet distribution.

In the spray coating process of the present invention, the air feed rate and nozzle-to-substrate distance should be carefully controlled to avoid capsule damage. In general, a nozzle-to-substrate distance of 200 to 320 mm is optimal, and this distance should be adjusted approximately inversely to atomization air velocity squared.

It has also been found that the quality and uniformity of the sprayed capsule coating can be strongly influenced by pretreatment of the substrate and by additives added to the capsule dispersion. Useful pretreatments and additives include but are not limited to:
1) Capsule dispersions that incorporate surfactants such as Triton X-100, butanol etc. to improve wetting of the substrate surface;
2) Pre-coating of the substrate surface with sub-layers incorporating surfactants such as Triton X-100, 1-butanol, and others possessing a detergent structure, and optionally a polyurethane latex;
3) Pre-treating the substrate with an atmospheric plasma or corona discharge treatment; and
4) The capsule dispersion may contain polymeric binders, for example a polyurethane latex

As already mentioned, the spray coating process of the invention may include the use of a masking material covering part of the substrate so that, after removal of the masking material, capsules remain only on those portions of the substrate where the masking material was not present. The masking material used to cover part of the substrate should not be porous, or at least should have low enough porosity to ensure that capsule deposition on to the masked areas of the substrate does not occur. The masking material should not significantly absorb the liquid (usually aqueous) in which the capsules are dispersed, and should be placed close enough to the surface of the substrate that lateral draft of capsules beneath the masking material from the unmasked regions of the substrate into the masked areas does not occur. After the capsules have been deposited on the substrate, the capsules may be dried (or otherwise treated to form a coherent layer, for example by exposure to radiation) with the masking material still in position, or the masking material may first be removed and then the capsules dried or otherwise treated. In either case, the physical properties of the masking material and the capsule dispersion should be chosen so that, during the removal of the masking material, capsules are not dragged into previously masked areas of the substrate, nor are capsules removed from unmasked areas (for example, by irregular tearing of a coherent dried layer of capsules.

The masking film may comprise an adhesive pre-laminated on to the surface on to which the capsules are to be deposited, and a release film exposed to the spray. After capsule deposition, the release film is removed, followed by additional processing. The resultant spray-printed film may then be laminated to a backplane, which may be either transparent or opaque. [Para 44] It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A color-changing object comprising:
a light-transmissive non-planar substrate;
a light-transmissive front conductor;
a layer of encapsulated electrophoretic media; and
a back conductor.

2. The color-changing object of claim 1, further comprising an adhesive layer.

3. The color-changing object of claim 1, wherein the back conductor is light transmissive.

4. The color-changing object of claim 1, further comprising a back substrate.

5. The color-changing object of claim 1, wherein the light-transmissive non-planar substrate comprises polyethylene terephthalate (PET), polycarbonate, polypropylene, acrylic, or cyclic olefin copolymer (COC).

6. The color-changing object of claim 1, wherein the light-transmissive front conductor comprises metal flakes, metal screen, conductive polymers, carbon nanotubes or a combination thereof.

7. The color-changing object of claim 1, wherein the light-transmissive front electrode is integrated into the light-transmissive non-planar substrate.

8. The color-changing object of claim 1, wherein the electrophoretic media comprises charged pigment particles dispersed in a solvent.

9. The color-changing object of claim 8, wherein the charged pigment particles include two sets of pigment particles with opposite charges.

10. The color-changing object of claim 9, wherein the first set of charged pigment particles is black and the second set of charged pigment particles is white.

11. The color-changing object of claim 8, wherein the charged pigment particles include three sets of pigment particles.

12. The color-changing object of claim 11, wherein the first set of charged pigment particles is red, the second set of charged pigment particles is green, and the third set of charged pigment particles is blue.

13. The color-changing object of claim 8, wherein the charged pigment particles include four sets of pigment particles.

14. The color-changing object of claim 13, wherein the first set of charged pigment particles is white, the second set of charged pigment particles is cyan, the third set of charged pigment particles is yellow, and the fourth set of charged pigment particles is magenta.

15. The color-changing object of claim 13, wherein the first set of charged pigment particles is black, the second set of charged pigment particles is red, the third set of charged pigment particles is yellow, and the fourth set of charged pigment particles is blue

16. A method of making a color-changing object comprising:
providing a light-transmissive non-planar substrate;
disposing a light-transmissive conductive material adjacent the inside surface of the light-transmissive non-planar substrate, thereby making the outside surface of the light-transmissive non-planar substrate the viewing surface;
disposing a layer of encapsulated electrophoretic media adjacent the light-transmissive conductive material; and
disposing a back conductor adjacent the layer of encapsulated electrophoretic media.

17. The method of claim 16, further comprising:
providing a voltage source; and
coupling the light-transmissive conductive material and the back conductor to the voltage source.

18. The method of claim 17, further comprising disposing a back substrate adjacent the back conductor

19. The method of claim 16, wherein the light-transmissive non-planar substrate is thermoformed, cast, injection molded, or blow-molded.

20. The method of claim 16, wherein disposing light-transmissive conductive material comprises spray coating, sputtering, atomic layer deposition, vapor deposition, or dip coating.

21. The method of claim 16, wherein disposing a layer of encapsulated electrophoretic media comprises spray coating, dip coating, electrodeposition, powder coating, silk screening, or brush-painting.

22. The method of claim 16, further comprising:
masking a portion of the light-transmissive conductive material;
removing the mask after disposing encapsulated electrophoretic media; and
connecting the light-transmissive conductive material to a voltage source.
